(19) United States
(12) Patent Application Publication
(10) Pub. No.: US 2008/0278335 A1
(43) Pub. Date: Nov. 13, 2008

(54) Automated pet entry door

(76) Inventor: Gregory A. Welte, Frankfort, IN (US)

Correspondence Address: Gregory A. Welte, 806 North Co. Rd. 700 West, Frankfort, IN, 46041, US

(21) Appl. No.: 12/151,258

(22) Filed: May 5, 2008

Related U.S. Application Data
(60) Provisional application No. 60/928,276, filed on May 8, 2007.

(51) Int. Cl. G08B 23/00; H04Q 5/22

(52) U.S. Cl. 340/573.3; 340/5.2; 340/10.1

(57) ABSTRACT

A locking pet-entry door for a building. The pet's collar is equipped with an RFID tag, or transponder. An RFID tag reader controls a lock on the pet-entry door. When the transponder comes within range of the RFID tag reader, the transponder transmits a code, which the RFID tag reader receives.

This is a continuation-in-part of application No. 60/928,276, filed on May 8, 2007.

The invention concerns a pet entry door, which automatically opens when a family pet approaches, but remains locked upon the approach of other animals.

### BACKGROUND OF THE INVENTION

FIG. 1 illustrates a common pet-entry door 3, installed in an ordinary household door 6, which allows a pet 5 to freely enter and exit.

One problem with door 3 lies in the fact that other animals can pass through door 3. Thus, unwanted guests such as raccoons and other critters can enter a house through the pet entry door. They can engage in mischief, such as rifling through trash bins and, if sufficiently experienced, can order take-out food using the telephone.

In addition, insects, such as mosquitoes, can enter the house, if the pet door 3 does not properly seal against the household door 6.

One form of the invention blocks entry of unwanted animals and insects, but allows a family pet to use a pet-entry door.

### OBJECTS OF THE INVENTION

An object of the invention is to provide an improved pet-entry door.

A further object of the invention is to provide a pet-entry door which detects the presence of authorized pets, and opens the door for them, but does not open the door for unauthorized animals.

### SUMMARY OF THE INVENTION

The invention utilizes RFID (Radio Frequency IDentification) technology. The basics of RFID will first be explained.

Two components are involved: an RFID “reader” and an RFID “tag.” The tag can be very small, about the size of a postage stamp, or smaller.

The reader transmits a radio-frequency signal, which acts as an interrogation signal. If the RFID tag is within range of the signal, the RFID tag responds by transmitting a code which the RFID tag contains, which the reader receives. On the other hand, if the RFID tag is outside the range of the signal, the RFID tag does not respond by transmitting the code, because the RFID tag does not detect the interrogation signal.

Different RFID tags are assigned different codes, so that the reader can identify the different RFID tags.

The reader-tag system can be used to open a pet entry door as follows. An RFID tag is affixed to a pet's collar. An RFID tag reader controls a lock affixed to the pet entry door.

The tag reader periodically transmits an interrogation signal. When the pet's collar arrives within range of the tag reader, the RFID tag affixed to the collar receives the interrogation signal, and responds by transmitting the code stored in the tag. When the reader receives the code, it opens the lock.

Significantly, if another pet, bearing another RFID tag on its collar, comes within range of the reader, the reader will not open the lock, because that tag does not contain the correct code. Also, if another animal, lacking an RFID tag, comes within range, the reader will also not respond, but for a different reason, namely, because the reader receives no response at all to the interrogation signal, since the animal carries no RFID tag.

### BRIEF DESCRIPTION OF THE DRAWINGS

FIG. 1 illustrates a pet-entry door 3, as known in the prior art.

FIG. 2 illustrates one form of the invention.

FIG. 3 is an enlargement of part of FIG. 2.

FIGS. 4, 5, and 6 illustrate a sequence of operation of the apparatus of FIG. 3.

FIGS. 7 and 8 illustrate another form of the invention.

FIG. 9 illustrates how a door 36, which pivots about axis AX, can be displaced into positions 36A by wind.

FIG. 10 illustrates another form of the invention.

FIG. 11 illustrates a sequence of positions which legs 93 in FIG. 10 can assume.

FIG. 12 illustrates an RFID tag 133 of the type used by the present invention, dangling from a pet collar 133.

FIG. 13 illustrates one approach to fastening an RFID tag 133 to a pet collar 130.

FIG. 14 illustrates canisters 150 into which an RFID tag 155 can be inserted.

FIG. 15 illustrates the canister 150 of FIG. 14 attached to a pet collar.

FIG. 16 illustrates one form of the invention.

FIG. 17 illustrates one form of the invention, which is sold in kit form, and which contains components described herein.

FIG. 18 illustrates a serpentine sealing system, which seals a pet-entry door D to its frame F.

FIG. 19 illustrates a sealing system, in which a pet-entry door 310 is sealed to a frame, but can swing bi-directionally.

FIG. 20 illustrates alternative cams which can be used in place of arms 93 in FIG. 10.

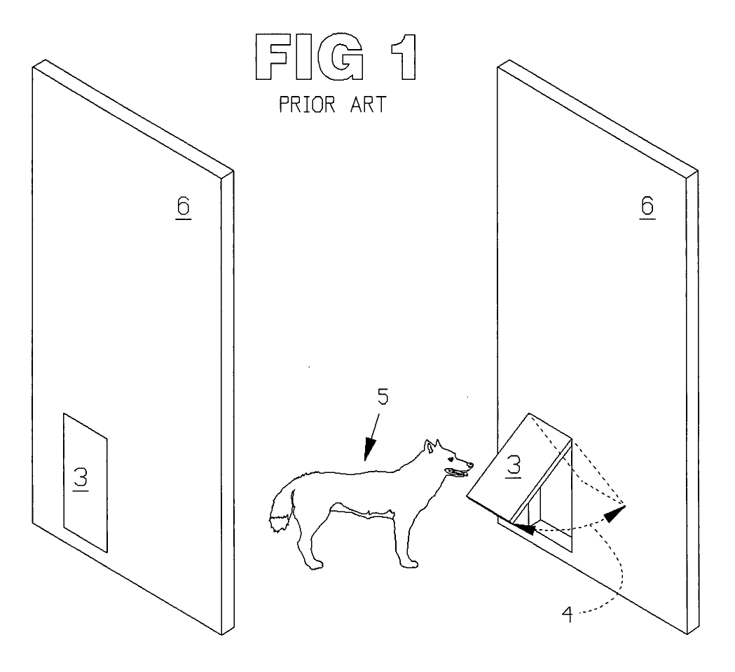

### DETAILED DESCRIPTION OF THE INVENTION

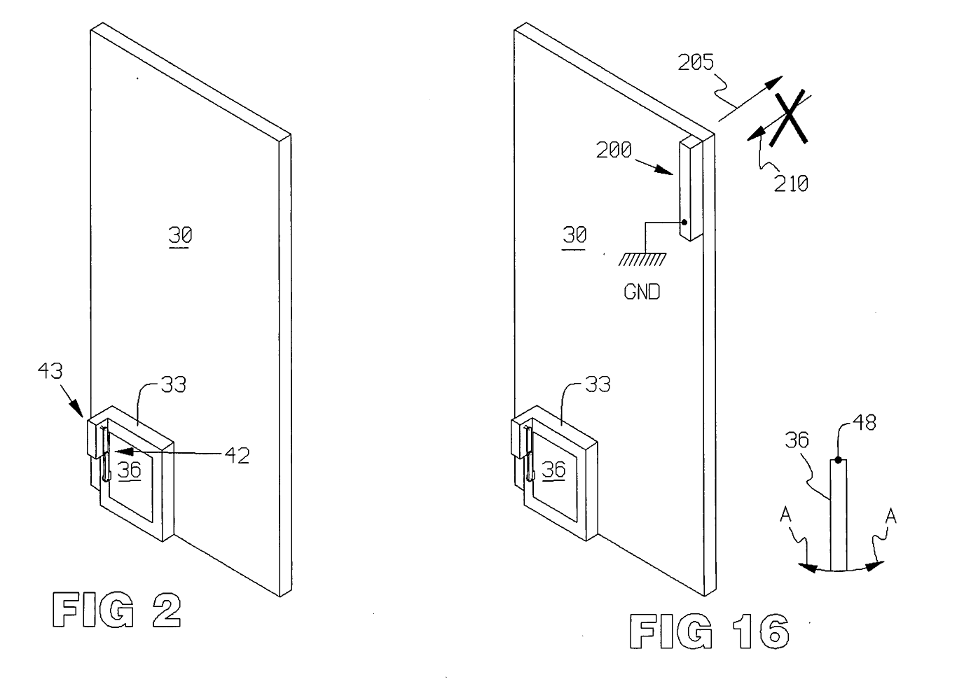

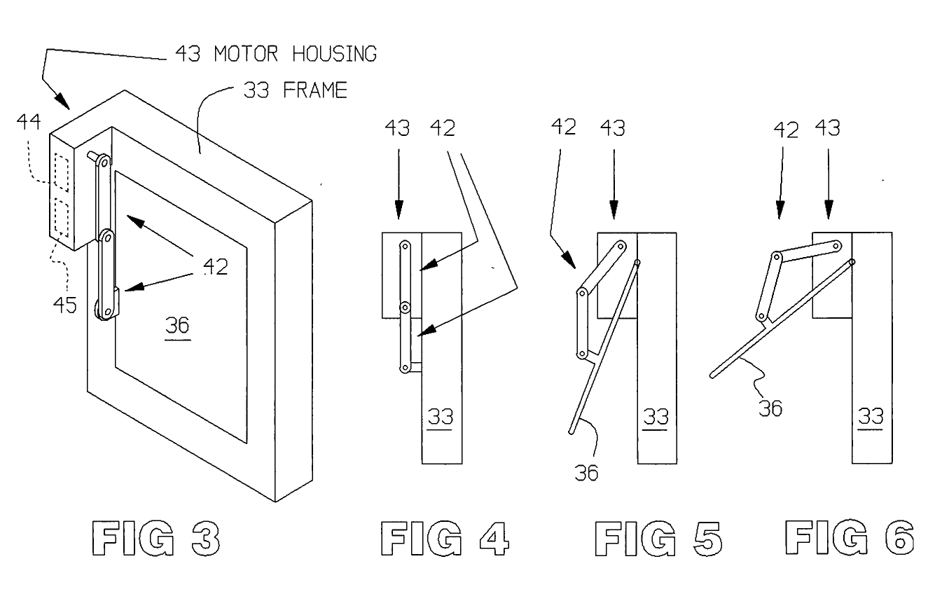

FIG. 2 illustrates an ordinary household door 30, to which is attached a frame 33, also shown in FIG. 3. The frame 33 supports a door 36. A linkage 42, powered by a motor indicated by phantom block 44 within housing 43, raises the door 36, as indicated by the sequence of FIGS. 4, 5, and 6. The motor 43 is actuated by an RFID reader 45 in FIG. 3.

Under this arrangement, when a proper RFID tag comes within range of the reader 45, the reader 45 causes the door 36 to open. Otherwise, the door 36 remains held closed by the linkage 42.

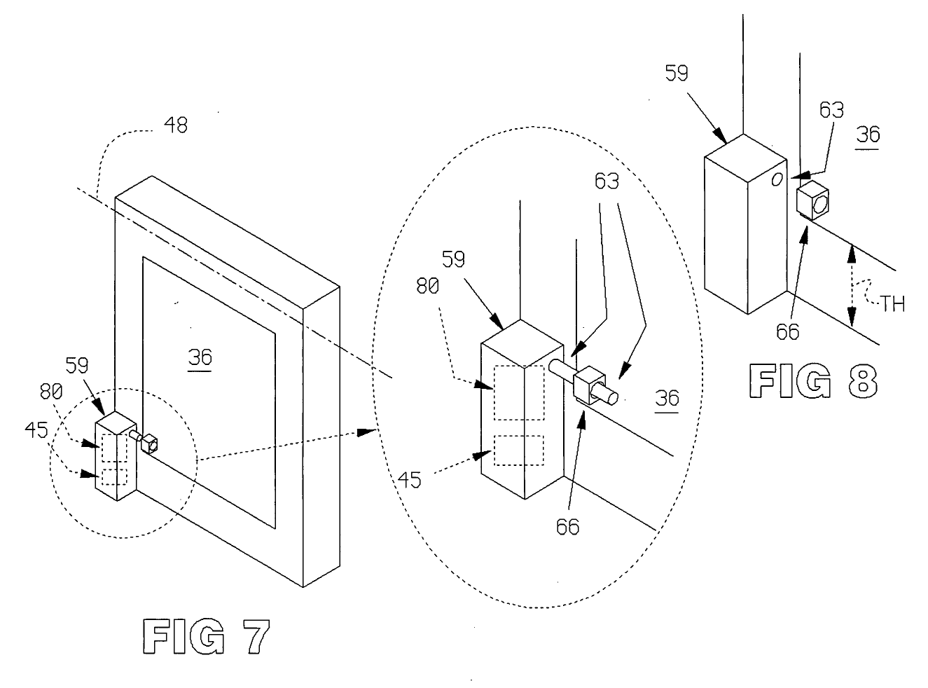

In another embodiment, the linkage 42 of FIG. 3 is not present, but the door 36 freely pivots about a horizontal axis 48 in FIGS. 7 and 16. The door can swing about axis AX in FIG. 9, between the positions indicated as 36A. The door 36 freely rotates in the direction of arrows A in FIG. 16.

A solenoid lock 80 in FIG. 7 is contained within a housing 59, together with an RFID reader 45. The lock 80 includes a bolt 63, which engages a shackle 66. The shackle 66 is attached to the door 36, so that, in the condition shown in the insert of FIG. 7, the door 36 is locked closed.

When the RFID reader 45 receives the proper code from an RFID tag, it actuates the lock 59, to withdraw the bolt 63, into the position shown in FIG. 8. Now the door 36 can freely swing about axis 48 in FIGS. 7 and 16, to allow a pet (not shown) to enter or exit the door 36.

RFID tags and readers are known in the art. RFID demonstration kits, manufactured by Texas instruments Corporation, are available from Digi-Key Corporation, Thief River Falls, Minn., USA (www.digikey.com). These kits are sold under the Texas Instruments TI-RFid™ trademark.

### Additional Considerations

1. In the absence of wind, the door 36 in FIG. 9 will tend to hang in a vertical position. However, if wind is present, door 36 may be urged into the position indicated by phantom lines 36A. In this situation, if the lock 80 of FIG. 7 is used, the bolt 63 may not be able to engage the shackle 66 and lock the door 36. The reason is that the shackle 66 may not be aligned with the bolt 63, because of the displacement of the door 36 from the vertical position.

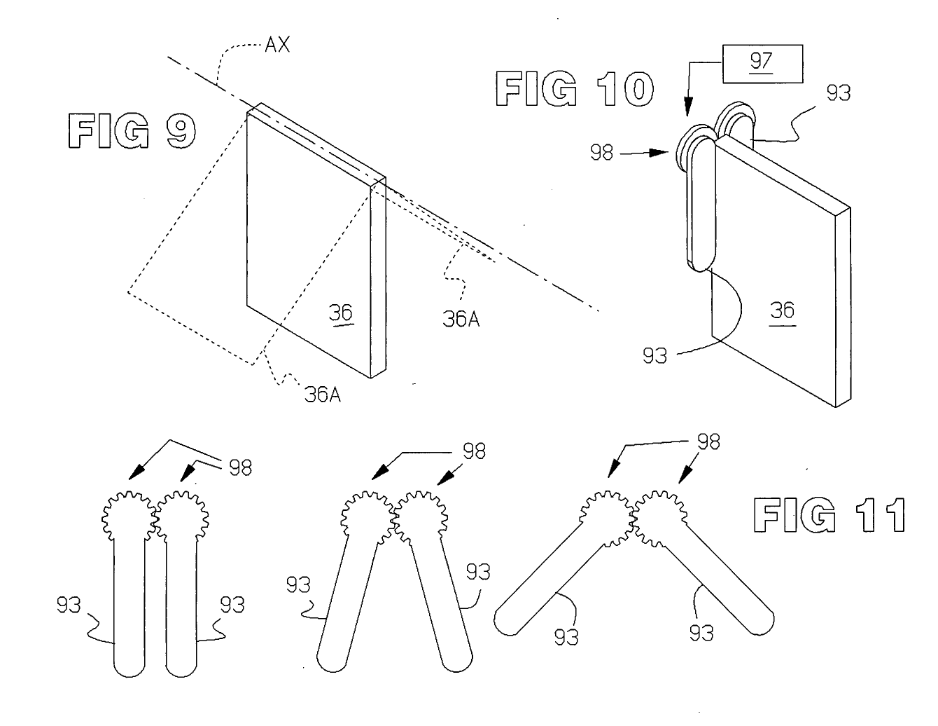

The apparatus 90 of FIGS. 10 and 11 can be used to resolve this situation. Arms 93 are selectively driven by a motor 97 to assume the positions shown in FIG. 11. In the position shown at the right side of FIG. 11, arms 93 allow the door 36 of FIG. 10 to open. As they move from those positions to the positions shown at the left side of FIG. 11, they progressively drive the door 36 into a vertical position, and capture and lock the door 36 at that position.

Coordinated movement of the arms 93 can be achieved by gears 98 in FIGS. 10 and 11. Alternately, linkages, known in the art, such as links-and-cranks, sprocket-and-roller-chain, can coordinate the movement.

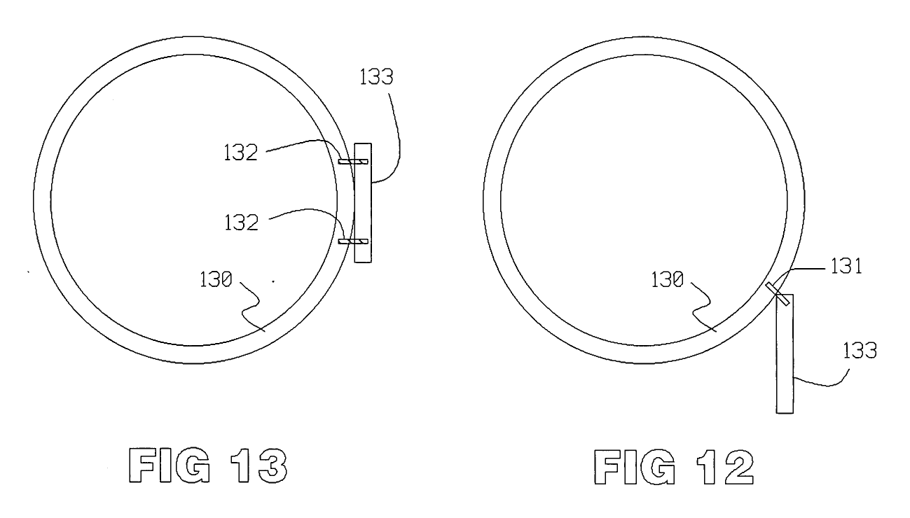

2. The RFID tag should not be subject to mechanical shock. One reason is that, under present technology, RFID tags are fabricated in silicon, which resembles glass in brittleness. Therefore, it is preferable that the mounting system shown in FIG. 12 be avoided, wherein the tag 133 dangles from a single lanyard 131. TO repeat, the tag 133 should not dangle from collar 130. One reason is that the tag 133 can flap about, and strike nearby objects.

Instead, it is preferred that the RFID tag 133 be fastened tightly to the collar 130, as in FIG. 13, so that the tag 133 is as parallel to, or conformal with, the collar 130 as possible. The use of two lanyards 132 can achieve this type of mounting. Alternately, a single wide band (not shown) can achieve this conformal mounting.

In addition, is preferable that the RFID tag 133 be mounted on the collar 130 as far as possible from any metallic license tags which may also be mounted on the collar 130. One reason is that such metallic tags can interfere with the radio transmission used by the RFID tag and the associated reader.

One cause of the interference is believed to lie in the fact that the metallic license tags can be significant in size, with respect to the wavelength of the radiation.

For example, the speed of light is 9.8×10̂8 feet per second. Round this to 10̂9 feet per second. If a frequency of 1 Gigahertz (10̂9 Hz) is used, then one wave is about one foot long. At 5 Gigahertz, the wavelength is about six inches. At 5 Gigahertz, a tag 140 which is one inch long is about ⅙ wavelength in length.

In one form of the invention, it is preferred that no metallic or conductive objects having a longest dimension which is 0.1, 0.2, 0.3, 0.4, 0.5, 0.6, 0.7, 0.8, 0.9, 1.0 wavelength of the radiation being used be attached to the collar 130. In another form, it is preferred that no metallic or conductive object having a longest dimension which is between 0.1 and 5.0 wavelengths of the radiation being used.

In another form of the invention, no metallic or conductive objects whatever are attached to the collar 130.

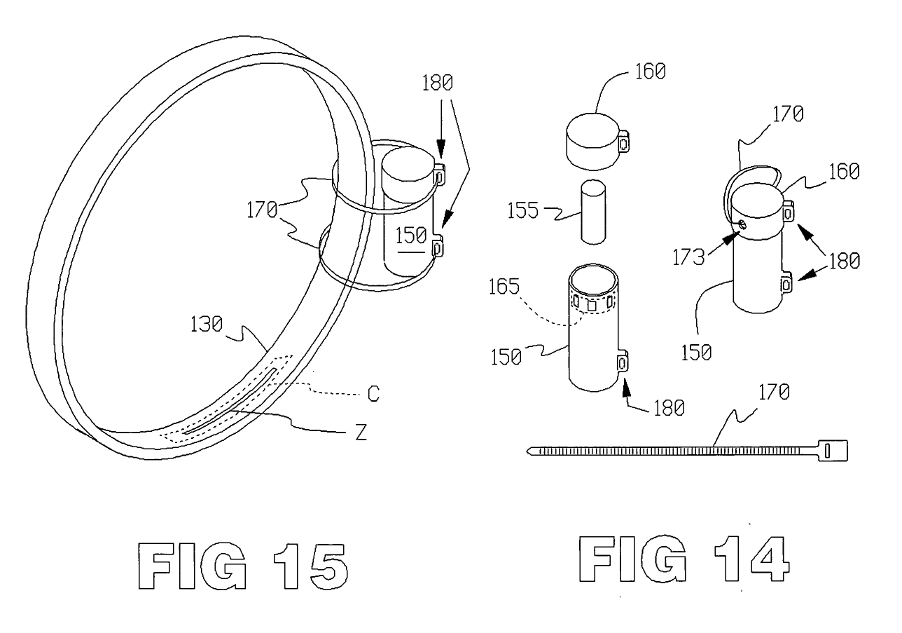

3. The RFID tag can be fastened to the pet collar 130 in several ways. FIG. 14 illustrates two canisters 150, into which the RFID tag 155 is inserted. A cap 160 attaches to the canister, through a locking mechanism 165 of the type used on prescription medicine bottles. Alternately, a cable tie 170, sometimes called a hanking cable tie, can be threaded through holes 173 in the cap 160/canister 150 assembly, to lock the cap 160 onto the canister 150.

The canister 150 can be, for example, ¾ inch in diameter and 2 inches long. Also, commonly available RFID tags are cylindrical, with a diameter of about 10 millimeters (mm), or just under ½ inch, and a length of about 37 mm, or about 1.5 inches. Other commonly available RFID tags are about 4 mm in diameter (about ⅙ inch), and about 24 mm long (about 1 inch). Another commonly available RFID tag is disc-shaped, about 30 mm in diameter and about 9 mm thick. The canister 150 is sized to contain a selected one of these tags, or all of these different sizes.

Loops 180 are provided, through which cable ties 170 in FIG. 15 can be threaded, to fasten the canister 150 to the collar 130.

4. In one form of the invention, the human-usable door 30 in FIG. 16, which contains the pet-entry door 36, swings in one direction only. That is, a stop 200 is present, which is anchored in place, as indicated by the ground symbol GND. When in the position shown, the door 30 can only swing in the direction of arrow 205. Door 30 cannot swing in the direction of arrow 210, as indicated by the “X” over that arrow. (Of course, if door 30 were open, then it could swing in the direction of arrow 210, in order to close.)

In contrast, the pet-entry door 36 can swing in two directions, as indicated by arrows A. The pet entry door 36 is a bi-directional swinging door, mounted within a human-usable door. The human-usable door can swing in a single direction.

Specifically, the pet-entry door 36 can swing in a first direction, such as eastward, to allow a pet pushing in the first direction to pass through the door in the first, eastward direction. It can also swing in a second direction, opposite the first, such as westward, to allow a pet pushing in the second direction to pass through the door in the second, westward, direction.

5. One may postulate a system wherein an RFID tag is carried by a human, and a locking system unlocks a door when the locking system detects an RFID tag nearby. However, such postulated systems are different from the present invention in several respects.

One difference lies in the fact that, under the invention, the pet-entry system system opens the door in two situations: (1) when the pet wishes to leave a building, and (2) when the pet wishes to enter the building. That is, the presence of the pet is detected on both sides of the door 30 in FIG. 16, and the door 36 is opened in both cases.

In the postulated locking system mentioned above, once a person enters a building, the system does not unlock a door to allow the person to leave. Such an operation would require that the person possess an RFID tag to exit the building. It is believed that numerous laws, such as fire codes, prohibit such a restriction. These laws require that “panic bars” be present on doors to allow persons within a building to exit unimpeded (although an alarm may sound).

Therefore, the postulated locking systems require an RFID tag to enter a building, but not to exit a building.

Another difference lies in the fact that, under the invention, the pet-entry door 36 which is opened is not usable by an adult of average size. In one form of the invention, the door is no taller than one foot. In another, no taller than 18 inches. In another, no taller than two feet. But, in all cases, the pet-door is not usable by an adult human of average size, such as 5 feet four inches in height, using a normal walking gait.

Yet another difference lies in the fact that, as shown in FIG. 16, the pet-entry door 36 is mounted within a human-usable door 30. A door-within-a-door is present. If a human were to use an RFID tag to open door 30, as in the postulated system, the pet-entry door 36 would remain closed (because the human has no need to use the pet-entry door 36).

6. As stated above, an RFID reader detects the code transmitted by the RFID tag. Different tags transmit different codes.

In one form of the invention, a second tag, with a second code, is present. This tag can be used to lock the pet door 36, and override the tag carried by the pet. For example, the logic associated with the RFID reader is programmed to open the door when the pet's code is received. It is programmed to ignore the pet's code when a blocking code is received.

Thus, if the owner of the pet places a blocking tag bearing the blocking code near the RFID reader, then the RFID reader is thereby blocked from opening the pet door 36. This latter tag acts as a remote control to enable, and disable, the locking capability of the pet-door.

As a specific example, the RFID reader is programmed so that it continually issues an interrogation signal. If that interrogation signal causes a blocking code to be received, then the RFID reader does not open the pet-entry door, even if the pet's code is received.

7. A remote control, similar to a garage opener or a television remote control, can be used to turn the RFID entry system on and off. When off, it does not respond to the pet's tag, and the pet-entry door 36 remains locked.

8. It may be desirable to detect the presence of an animal, as by using a motion detector or a weight-sensitive mat. As another alternate, the presence of an animal can break a light beam and thereby generate a pet-presence signal.

Irrespective of how the presence of the animal is detected, the pet-presence signal induces the RFID tag reader to issue an interrogation signal. If the animal does not bear the proper RFID tag, then the proper code will not be returned to the tag reader, and the reader will not open the pet-entry door.

Conversely, if the pet is present, wearing the RFID tag, the proper code will be received, and the door will open.

This approach eliminates a need for the RFID reader to continually issue interrogation signals, which is done in some forms of the invention.

9. In one form of the invention, after the lock of the pet-door is opened, it is not re-locked immediately, but is re-locked after a delay. This allows time for the pet to travel through the door.

Alternately, the system can continue to issue more frequent interrogation signals at this time, to detect whether the pet has left the proximity of the door. That is, the tag reader will possess a finite detection range, outside which the pet's RFID tag will not respond. If it is inferred that the pet has left the detection range, because of the cessation of the response signals from the RFID tag, then the door is re-locked.

As a specific example, the interrogation signals may ordinarily be issued every 5 seconds. When the pet is detected, the door is opened, and the interrogation signals are then issued more frequently, such as every second. When the pet's RFID tag receives each interrogation signal, it issues a response, as usual.

When the responses terminate, it is assumed that the pet has left the detection range, and the door is re-locked.

As another alternate, if the responses do not terminate, because the pet remains within the detection range, the door is re-locked after a time delay, such as ten seconds.

Re-locking also refers to re-closure, in the embodiments such as that of FIG. 11.

10. Suitable safety mechanisms are implemented, to prevent injury to the pet, when a door-opening system such as that of FIG. 3 or 10 are used. Such mechanisms are found, for example, in electric window mechanisms used in automobiles.

11. Sometimes people are seen wearing ID badges around their necks, in the manner of a necklace. In one form of the invention, this arrangement is not preferred for attaching an RFID tag to a pet, for one or more of the following reasons.

One reason is that a necklace dangling from the neck of a dog can become entangled in bushes, and thereby trap or injure the dog. A second reason is that such a necklace can draw the attention of miscreants to the animal, who may attempt to steal the necklace.

Consequently, it is preferred that the RFID tag be affixed snugly to the animal, as by embedding within the animal's neck collar.

In one form of the invention, a tag is fastened to the collar normally worn by the animal. Such collars are characterized by the fact that they are generally loose enough that they do not choke the animal, but sufficiently tight that the animal cannot slip its head through the collar, and thereby remove the collar.

The tag is either embedded within the collar, or tightly fastened to the collar, so that the tag does not dangle as shown in FIG. 12.

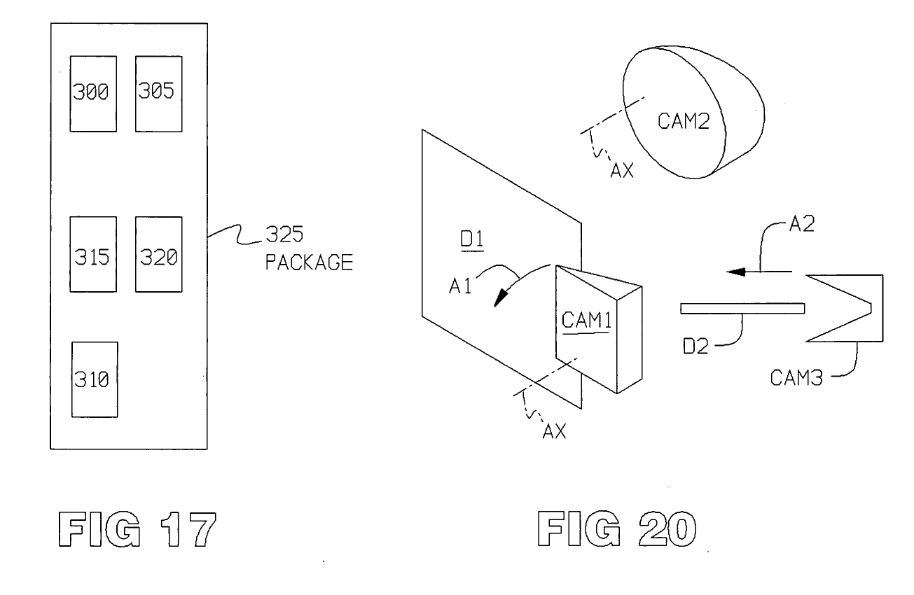

12. In another form of the invention, several components are packaged as a kit, which is purchased and then used by a customer. The customer installs a door, of the type symbolized in FIG. 2 for example, and places an RFID tag on the pet. FIG. 17 illustrates the components of the kit, which are contained in a single package, such as a blister-pack.

Those components include some combination of the following. A pet collar 300. One or more RFID tags 305, in which are stored code(s) which are recognized by an RFID tag reader 310, which actuates a door mechanism when a code is received, as described herein. The kit includes a door assembly 315, such as that shown in FIG. 2 or 10 for example, which the reader 310 can actuate and de-actuate. A mounting system 320 is included to attaching the RFID tag 305 to the collar 300.

Alternately, the collar may be constructed with an RFID tag embedded within it, analogous to a money belt. For example, the collar may contained a zippered compartment C in FIG. 15, with the zipper Z concealed on the inner side of the collar, so that the zipper cannot be seen when the animal wears the collar.

Significantly, in one form of the invention, when the components are in kit form, they can be inactive. That is, no lock within the kit opens when an RFID tag approaches the lock. One reason can be that the lock is not powered. Another reason can be that there is no movement between the RFID tag and the lock: these components can be fixed in space with respect to each other, as by being trapped in their packaging.

Further, when the components are in kit form, no animal wearing an RFID tag passes through the door contained in the kit.

One characteristic of the kit form is that numerous kits can be stored, or displayed, in a common place, such as a shelf in a retail store. Such storage would not make sense for a group of pet-entry doors which are in actual use.

13. In one embodiment, the RFID tag worn by the pet is not self powered. It receives all operating power from the incoming interrogating signal. Consequently, the RFID tag does not continually or periodically transmit radiation, visible or otherwise, except when interrogated. And upon interrogation, it transmits radio-frequency radiation, which is invisible to humans.

14. In one form of the invention, a specific advantage is secured, namely, that the component, or tag, attached to the pet's collar requires no electrical batteries as a power source. Consequently, battery failure or exhaustion cannot interfere with operation of the invention.

In contrast, if batteries were required, then the pet owner must be concerned about the reliability of the batteries attached to the pet. If the owner were to leave on a vacation trip, the owner would most likely insert fresh batteries into the device carried by the pet, to assure that the pet could continually use the pet-entry door during the owner's absence. This is considered a nuisance, and is avoided by the invention.

From another perspective, if the device attached to the pet's collar required batteries, then, as a practical matter, if the pet owner wished to leave on a vacation, the pet owner must check the level of charge in the batteries. This requires a battery level indicator. If the pet owner lacks a battery level indicator, then the pet owner cannot know whether the device will be operative during his absence, and would probably install fresh batteries for that reason.

It may be thought that the pet owner could check the batteries by bringing the pet, or the device, adjacent the pet-entry door, and seeing whether the door operated because of the presence of the device. However, even if the door opens, this approach does not indicate that the batteries are sufficiently charged to operate for any known period of time. This approach simply indicates that the batteries were sufficiently charged to execute a single door-opening. Further, this approach depletes the batteries somewhat, thereby reducing the charge present for future usage.

Still further, because of the physical properties of many batteries, such an approach can provide misleading information. For example, ordinary zinc dry cell batteries, when nearly depleted, can periodically provide small surges of power, if given a “rest period” between surges. As a specific example, if a radio is powered by nearly depleted batteries, one can turn on the radio, and it may play for a few seconds. If one then cycles the radio off-then-on, it may not play at that time. But if one turns it off, waits a few minutes, and then turns it on again, it may play again for a few seconds.

Thus, for some types of batteries, testing whether they can deliver power (1) is not a reliable method of determining whether they are dead, (2) does not indicate the level of charge which they contain, and (3) does not indicate whether, and how much, power they can supply in the future.

The invention does not suffer from these problems. A pet owner knows that the pet can be left alone, and still be able to use the pet-entry door, without any concern for batteries (provided, of course, that the electrical system in the house remains operative, which is considered reasonable to assume).

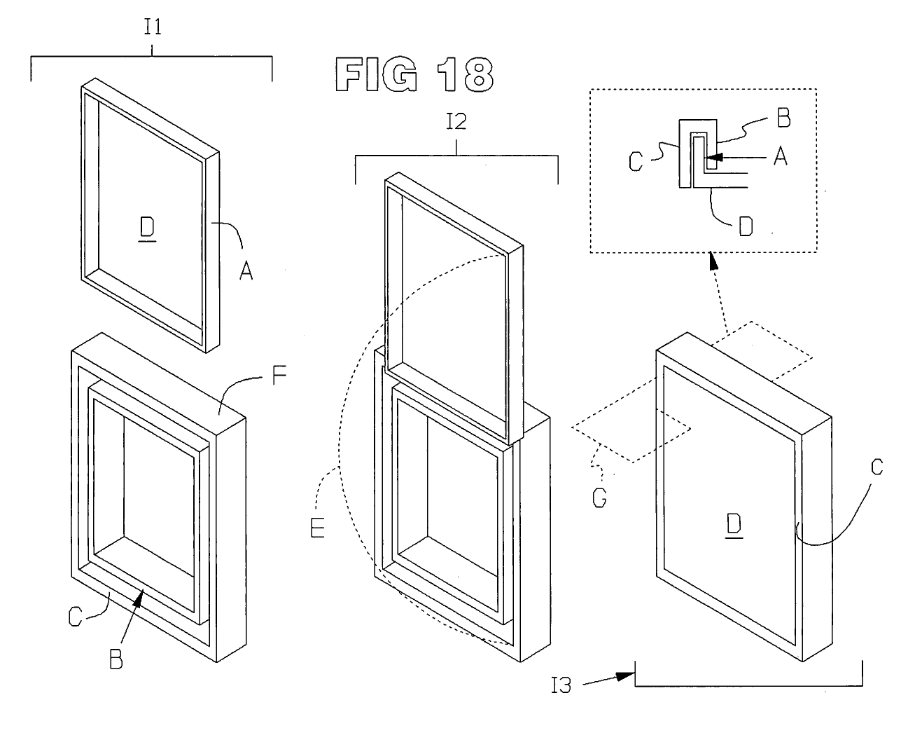

15. FIG. 18 illustrates a sealing system for one type of pet-entry door. Image I1 shows a door D separated from its frame F. Image 12 shows the door D attached to the frame F, and the door D can swing about a hinge (not shown) as indicated by dashed path E.

Image 13 shows the door D in a closed position. A cross-sectional view is indicated by the dashed insert, and taken in plane G. It is seen that door D contains a flange D which is captured between flanges B and C, the latter two flanges being connected to the frame F.

The three flanges A, B, and C act as a labyrinth seal, and required incoming air to follow a serpentine path (not shown), in order to pass through the pet-entry door system.

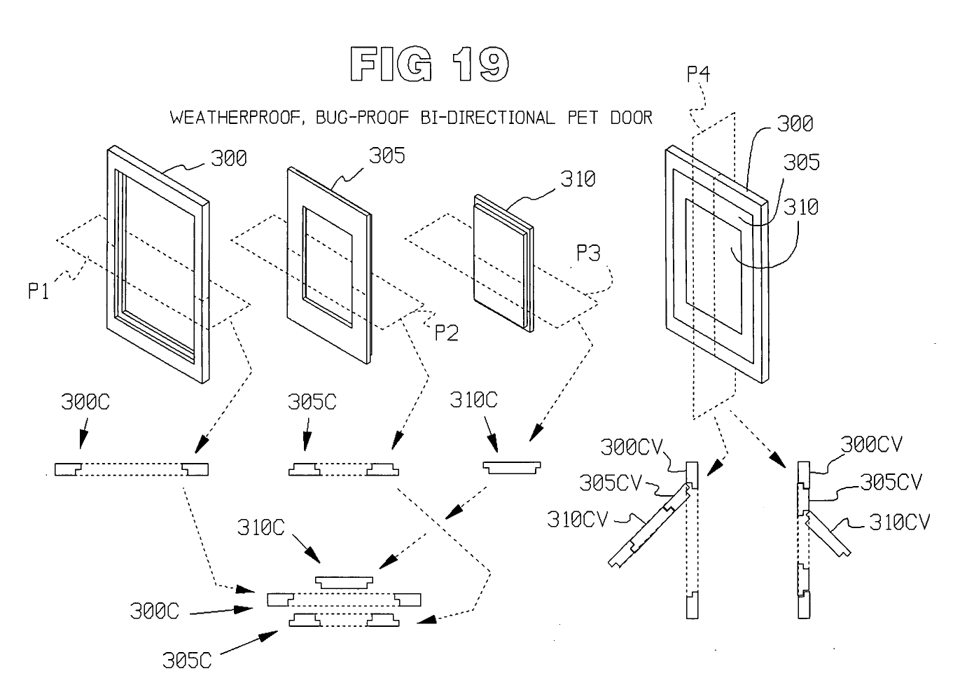

16. FIG. 19 illustrates a sealing system which blocks weather and also insects, and yet allows the door to swing bi-directionally.

A hollow frame 300 is shown at the left side of the Figure. To the right of the hollow frame 300 is another hollow frame 305, and to the right of that is a solid door 310.

Cross sections of these three elements are taken in planes P1, P2, and P3. Those cross sections are indicated as 300C, 305C, and 310C.

Those cross sections 300C, 305C, and 310C are stacked, but in exploded form, at the bottom of the Figure, to illustrate their mutual interaction.

The three components are shown assembled at the right side of the Figure. Two cross sectional views are taken, in plane P4, and are shown at the lower right side of the Figure. Door 310CV can swing to the right, as indicated, while hollow frames 305CV and 300CV remain stationary.

Door 310CV, together with frame 305CV, can swing to the left, as shown, while hollow frame 300CV remains stationary.

This arrangement allows effective sealing of the overall door system against weather and insects, by applying weatherstripping to the flanges shown in the Figure, while allowing a pet to enter or exit by pushing against panel 310.

The locking systems of the other Figures can be applied to the systems of FIGS. 18 and 19.

17. The arms 93 in FIGS. 10 and 11 can be viewed as operating as cams, in urging the door 36, when ajar, into a closed position. FIG. 20 illustrates alternative cams.

Wedge-shaped CAM1 can close door D1 when it rotates in the direction of arrow A1, about axis A1. CAM2 illustrates a cam of alternate shape.

Door D2 is a cross-sectional view of the door, taken from above. Cam CAM3, when moved in the direction of arrow A2, will close door D2, if ajar.

Cams can be placed on both sides of a swinging door.

18. Some distinctions should be drawn between aspects of the present invention and other, hypothetical, approaches.

A hypothetical pet may be equipped with a device, attached to the pet's collar, which repeatedly transmits a signal. A receiver receives the signal, and opens a door. However, the device probably requires electrical power, which means that electrical batteries must be occasionally replaced.

Further, depending on the type of signal transmitted, multiple detectors, or antennas, may be required. For example, if the signal is optical, it will not travel through walls. Thus, a detector is required on the inside of a house, to open the door to allow the pet to exit the house, and a second detector is required on the outside of the house, to open the door to allow the pet to enter the house. A similar comment may apply to an acoustic signal.

In contrast, a radio-frequency signal can travel through many types of walls, thus allowing a single detector, or antenna, to be used.

Further, as discussed above, the RFID tag carried by the pet transmits a multi-bit code, which, in effect, is a number. Different RFID tags have different codes. Thus, even if another animal is present with its own RFID tag, the code of that tag will probably be different from that of the pet's tag.

19. The pet door can be locked by a door lock, which is locked and unlocked by the RFID reader. Alternately, the pet door can be opened and closed by an operating mechanism, which can be called a door closure mechanism. The door closure mechanism can also act as a lock, for example, by holding the door closed, and requiring that damage be inflicted on the mechanism, if the door is to be opened in the absence of a signal from the RFID tag.

Also, a separate lock may be provided, in addition to the closure mechanism, which is actuated in coordination with the closure mechanism.

20. In one form of the invention, the pet door contains no handles or knobs which are operated or used by the entity which uses the door, namely, the pet. This contrasts with a door operated by humans which will, in general, be equipped with handles or knobs.

One reason for the lack of handles and knobs is that the paws of a dog or cat lacks the manipulative ability of the human hand. Another reason is that, in many cases, the animal does not use its paw to open the pet door, but instead pushes against the door with its forehead.

A third reason is that, in many doors, a handle serves the purpose of keeping human hands off the door itself, which may be made of glass. The hands would leave prints on the door.

21. In one form of the invention, the bottom of the doorway is not flush with the floor. Instead, a high threshold is present, as indicated by dimension TH in FIG. 8. One purpose of the high threshold is to add structural strength to the frame which surrounds the door. Without the high threshold, the frame may have the form of an inverted U, with no cross-bar at its bottom.

Another reason for providing the high threshold is that clearance at ground level is not needed. For example, in an ordinary door used by humans, it is convenient for the humans to walk through the door, using a swinging gait of their legs. It is less convenient for them to take high steps, to clear an obstacle. Further, the humans may be pushing carts, or wheelchairs may be using the door. All of these considerations militate against using a high threshold, or a threshold having any height at all.

In contrast, it is easy for dogs and cats to lift their legs to the level of their bodies, to clear a high threshold.

22. Humans sometimes wear ID badges as necklaces, or attach the ID badges to their clothing. Sometimes the ID badges act as keys to unlock doors. The Inventor points out that such ID badges are not analogous to an RFID tag attached to a pet, for at least several reasons.

One reason is that the human does not wear the ID badge 24 hours per day. In contrast, the RFID tag is worn by the pet constantly, although exceptions can exist of course.

Another reason is that the donning of the ID badge by a human is a voluntary activity. This is not the case for the RFID tag on a pet: the pet does not choose to wear the tag.

Yet another reason is that the human places the ID badge onto himself. A pet does not do this. The pet's owner will generally place the RFID tag onto the pet.

23. As stated above, if a human uses an ID badge to gain entry through a door in a building, that door generally allows the human to exit the building without the ID badge. Such doors are equipped with “panic bars” to allow such exiting. A panic bar is generally a horizontal bar which extends across a door. Pushing on the panic bar serves to unlock the door, and further pushing moves the door into an open position.

The pet entry door is not equipped with panic bars for the pet, although a human-usable door in which the pet entry door is installed may be equipped with panic bars.

24. The word “open,” as in “open the door,” generally has three meanings. One, it can mean to unlock the door, but to leave the door in a closed position. Two, it can mean to move the door into an open position. Three, it can mean to both unlock the door and to move the door into an open position.

25. The term RFID is a term-of-art. It refers to Radio Frequency IDentification, wherein an RFID tag receives an interrogation signal and, in response, transmits data stored in the tag. Other RFID tags may allow data to be written to the tag.

In the present invention, the RFID tag attached to the pet is preferably of the non-self-powered type. That is, it contains no batteries, but receives its operating power from the incoming interrogation signal.

Numerous substitutions and modifications can be undertaken without departing from the true spirit and scope of the invention. What is desired to be secured by Letters Patent is the invention as defined in the following claims.

1. Apparatus, comprising:
a) an RFID reader which issues a radio-frequency, rf, interrogation signal;
b) an RFID tag, which receives the rf interrogation signal and, in response, transmits an rf code;
c) a fastening system which enables a human to attach the RFID tag to a non-human animal; and
d) a door actuation apparatus effective to control a pet entry door, which apparatus the RFID reader actuates when the RFID reader receives the rf code.

2. Apparatus according to claim 1, in which an adult human of average size cannot pass through the pet entry door in an upright walking gait.

3. Apparatus according to claim 1, and further comprising a shipping container in which (1) the RFID reader, (2) the RFID tag, and (3) the door actuation apparatus are contained.

4. Apparatus according to claim 3, in which the RFID reader (1) receives operating power from house current during normal operation, and (2) receives no operating power when in the container.

5. Apparatus according to claim 1, in which the door actuation apparatus
i) comprises a lock which is effective to hold a pet entry door in a closed position, and
ii) is effective to open the pet entry door when the predetermined code is received.

6. Apparatus according to claim 1, in which the door actuation apparatus
i) comprises a mechanism which is effective to move a closed pet entry door into an open position, and
ii) is effective to actuate the mechanism when the predetermined code is received.

7. Apparatus, comprising:
a) a human entry door in a building, through which an average-sized human can walk in a normal gait;
b) a pet entry door mounted in the human entry door, through which an average-sized human cannot walk in a normal upright gait;
c) a locking system which holds the pet entry door closed;
d) an RFID reader which
i) transmits an interrogation signal, and
ii) issues a release signal to the locking system if a predetermined code is received in response to the interrogations signal, said release signal being effective to release the pet entry door from the closed position;
e) an RFID tag which transmits the predetermined code when it receives the interrogation signal; and
f) a carrier for attaching the RFID tag to a pet collar.

8. Apparatus, comprising:
a) a swinging door, which is mountable in an aperture in a door in a building, and which
i) swings in a first direction to allow a pet to pass through the swinging door in the first direction; and
ii) swings in a second direction, opposite the first direction, to allow the pet to pass through the swinging door in the second direction;
b) a locking system which
i) locks the swinging door in a fixed position, and inhibits swinging in both the first and second directions; and
ii) unlocks the swinging door when it receives a release signal;
c) an RFID tag which transmits a code when it receives an interrogation signal;
d) an RFID reader which
i) transmits said interrogation signal, and
ii) issues the release signal if said code is received in response to the interrogations signal; and
e) a carrier for attaching the RFID tag to a pet collar.

9. Apparatus according to claim 8, in which the interrogation signal is transmitted periodically.

10. Apparatus according to claim 1, in which the RFID tag contains no batteries, and receives its operating power from the interrogation signal.
